(19) United States
(12) Patent Application Publication
(10) Pub. No.: US 2008/0220729 A1
(43) Pub. Date: Sep. 11, 2008

(54) Device and System for Radiofrequency Communication in Urban or Road Environments

(76) Inventor: Franc Roda Avila, Barcelona (ES)

Correspondence Address: Franc Roda Avila, C/ Mallorca 257 ent 2a, Barcelona, 08008, omitted

(21) Appl. No.: 11/997,955

(22) PCT Filed: Aug. 4, 2006
(86) PCT No.: PCT/ES2006/070127

§ 371 Date: Feb. 5, 2008

(30) Foreign Application Priority Data
Aug. 5, 2005 (ES) P200502017
Aug. 5, 2005 (ES) P200502019

(51) Int. Cl. H04B 1/38

(52) U.S. Cl. 455/90.3

(57) ABSTRACT

The invention relates to a device for radiofrequency communication in urban or road environments, comprising a luminaire of common use in street lighting which incorporates at least one transceiver with at least one data input and at least one data output coming from one or more antennas that operate in the radiofrequency band. The aforementioned type of light provides a suitable solution in terms of housing, electrical power supply, height and distribution for the respective transceivers owing to the design and usual arrangement thereof in urban or road environments. This way, the resulting assembly is particularly suitable for the provision of information-based services in general, and for the transmission of data in particular, in a communications system where the different nodes communicate with one another and with the user terminals.

### FIELD OF INVENTION

The present invention relates to the sector of telematics and to systems for data transmission and processing, for to the provision of services based on information communication in urban areas. More particularly, it relates to the field of radiofrequency communication in urban or road environments.

### BACKGROUND OF THE INVENTION

In the last years, due to the rise of the information technologies, most cities and urban centers have experienced an important proliferation of infrastructures related to data transmission, such as the installation of different kinds of cable connections under the urban pavement, or the installation of base stations for mobile telephony on the roofs of many buildings. Both solutions present important drawbacks, mainly due to the nuisance and social rejection stemming from its implementation, regarding street works, noise and loss of mobility in the first case, and visual and electromagnetic contamination in the second.

In general, wired solutions have by definition the limitation of requiring a use necessarily static of its services. In turn, the disordered way of deploying the present networks of mobile telephony in urban environments does not appear to be the most suitable for resolving the question of providing network coverage and access to network services to those areas, specially in metropolitan regions, as both the demand and services grow and get consolidated.

At the present time, there are many cities with a number of independent access points offering internet connectivity, known as hotspots, which are generally spread across airports, railway stations, hotels and other facilities generally related to mobility. There is no record, however, of the existence of luminaires adapted for data transmission whereby it is possible, taking advantage of their constitution as well as their advantageous layout in urban or road environments, to offer services related to the world of information.

There is no record, either, of the existence of communication systems which take advantage of these characteristics to fulfill the needs of the respective network nodes, allowing the communication between the different nodes and between these and the user terminals; as well as of the steps needed to adapt the receiving elements to carry out the new functions.

### DESCRIPTION OF THE INVENTION

The present invention relates to a luminaire, such as the ones commonly used for public lighting, in which a transceiver has been previously installed. In this context, a transceiver designates the set formed by a transmitter and a receiver, which may operate simultaneously or alternatively depending on whether they share or not part of their components, having to that effect at least one data input and one data output coming from one or more antennas that operate in the radiofrequency range.

There are many advantages of adding a radiofrequency transceiver to a public lighting luminaire. A first characteristic comes from the fact that these lighting fixtures, specially those where the reflector is integrated inside the body of the frame, have a certain amount of empty space in its interior, in which it is possible to install the transceiver.

Another important characteristic comes from the fact that this type of luminaires have in themselves the appropriated means for supplying electric power, and may therefore solve the electrical needs of the transceiver. Providing an electric supply is generally one of the main factors related to wireless infrastructures, since a wired connection to each node must be provided. This means that the whole network must still have a dependency on a wired environment, which may become a serious issue in large installations, with relatively close nodes, uniformly distributed in an area. The suitability of the proposed substrate in this case not only manifests itself in terms of geometric configuration, but also by the fact of being a source of power supply, enabling the connection to it by means of an electric adapter and removing the need to deploy additional wiring, which considerably simplifies this issue.

Besides solving the housing and power needs of the transceiver, another aspect derived from the usual layout of this type of luminaires in urban or road environments is the ability to provide the appropriate elevation conditions. This on one hand favors the reciprocal visibility of the different transceivers, and on the other, enables them to provide network coverage on a nearby environment, specially to the immediate roadway and facade planes. In this aspect, the distance to the immediate roadway and facade planes represents a distance small enough for transmitting the signal with low intensity antennas, thus complying with the most restrictive regulations. In the base of a lighting post with one of this adapted luminaires on its top, the power density obtained, taking into consideration an emitting power of 0.1 W according to municipal regulations and an installation height of 10 m, is 0.008 μW/cm², about 10 times lower than the most stringent limits which specify a maximum power density level of 0.1 μW/cm².

There are, likewise, precedents of the removal of base station antennas dedicated to mobile telephony, due to the fact that they represent a direct aggression to the urban landscape, and run contrary to the ordinances which regulate this aspect. In the proposed case, however, when all of the components are housed within the own body of the luminaire, the whole installation becomes completely imperceptible from the point of view of visual contamination.

Finally, another important characteristic arises from the fact that the typical distance between two adjacent points in a usual distribution of public lighting in urban areas usually remains below 20 meters. This represents a distance considerably lower than the average reach of the typical commercial solutions for data transmission for house or office use, as for example those which operate at 2.4 and 5 Ghz frequencies, which usually provide a coverage between 50 and 150 m on open space, being able to reach 300 m or even more with a direct line of sight. Taking into account, therefore, that the proposed substrate defines an essentially uniform distribution in the public space of a urban environment, it is possible to provide data services related to mobility in public space, as well as data services related to static uses in private space, and particularly the communication in both cases of several fixed or mobile user terminals, through a number of this kind of luminaires, which communicate with each other and with the user terminals.

### BRIEF DESCRIPTION OF THE DRAWINGS

To complement the present description and with a view to contributing towards a better understanding of the characteristics of the invention, in accordance with a preferred embodiment thereof, a set of drawings is attached as an integral part of this description, that by way of illustration but not limitation, represent the following:

FIG. 1 is a schematic representation in plan view essentially showing a block diagram with a luminaire that is equipped with a radiofrequency transceiver.

FIG. 2 is a schematic representation in plan view essentially showing a luminaire where the radiofrequency transceiver is part of an integration board that also includes a processor, a means of volatile memory and a means of non-volatile memory.

FIG. 3 is a schematic view of an elevation essentially showing the upper and lower parts of a lighting post housing several components related to data transmission.

FIG. 4 is an auxiliary view of the set represented in FIG. 3.

### DETAILED DESCRIPTION

Both the telecommunications and computer sectors are characterized by a great variety of solutions and a constant renewal of their implementations. It must not be understood that the object of this specification is restricted to a solution or a range of products which follow a specific standard, protocol or format, but that it makes reference to those which met the requirements herein specified.

Although to a lower extent, there is also a great variety concerning the format of the different kinds of lighting fixtures or luminaires by which the public lighting in urban areas is solved. A first classification may be established between those luminaires which are essentially formed by a housing and a reflector, and those which have a diffusing screen surrounding the lamp. Within the first group, which is the most suitable for the invention, a distinction must be made between those luminaires whose reflector is located outside the main body of the framing, and those where the reflector is integrated in it. Although both cases are within the scope of the invention, the following specification will be based, because of its more appropriate characteristics and without loss of generality, in reference to a one-body luminaire. In this type of luminaires, since they are made of a single framing and since the reflector is the wider component in its interior, a certain amount of empty space is defined in the rear part, in which both the transceiver 2 and the transformer 5 may be integrated.

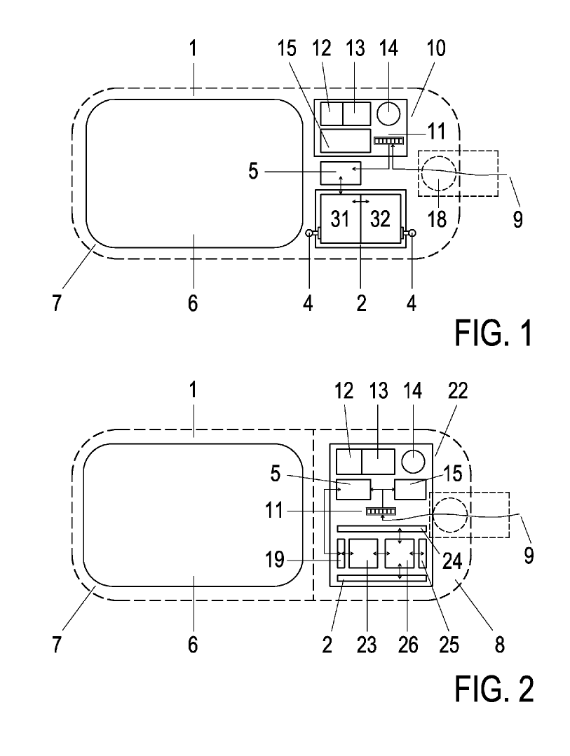

FIG. 1 shows a schematic representation of a luminaire 1 with the reflector 6 integrated in its interior, and a component board 10 in the rear part which integrates the usual components for the proper operation of the lamp. These components usually consist of an igniter 12, a reactance 13, a capacitor 14, a connection block 11, and in some cases a power adapter 15 that provides a feeding voltage generally between 95 and 125 V. One of the main characteristics of the light fixture in the figure is to include, besides the aforementioned components, a transceiver 2, formed by a transmitter 31 and a receiver 32, which are connected to respective antennas 4 that operate in the radiofrequency band, thus enabling it to communicate with the nodes and users nearby.

To better understand, in this sense, the size of the elements represented in the figures, the luminaires of this type usually have an approximate dimension of 70 cm long by 30 cm wide. In turn, the common transceivers for home or office use usually have an approximate dimension of about 10 cm to 15 cm, with a height between 1 and 3 cm depending on whether they include a casing. This way, it is possible to integrate them in the space located at the back of the luminaire, between the reflector 6 and the housing 7. In particular in this situation, given its proven waterproofing characteristics, the framing of the luminaire or a part of it may act directly as a housing for the transceiver, so that the transceiver may reduce itself to an integrated circuit board, thus requiring a lower volume and simplifying the integration process.

Since it is a flat and unobstructed surface, a solution when the inner space is quite limited is to secure both the transceiver 2 and the power adapter 5 directly under the lid of the main housing by means of horizontal guides or other means which may be part of the own design of the housing 7. However, when the transceiver is installed in the interior of a lighting fixture to be used for the lighting of important roads, it must be taken into account that the lamp in this case may require a power of 400 W or even more, increasing the inner temperature well above 40° C. Therefore, it may be preferable to install the transceiver in a separate compartment 8 in relation to the reflector 6, with the specific purpose of housing the transceiver or other network components.

In this sense, to reduce the temperature of the luminaire, while at the same time trying to preserve the protective rating which defines its watertight characteristics, it may include means for controlling the inner temperature, such as a small fan placed at the mounting point 18 of the lighting post, thus taking advantage on one hand of its hollowness to expel the air, and on the other, of its metallic constitution to dissipate the heat to the outside, without having to pierce any of the protective or wrapping elements. To further lower the heat radiation towards the inside, which originates mainly at the surface of the reflector, a thermal insulating coating may be added around it, including one or more layers of porous or ceramic insulating material, preferably separated from the reflector by small supporting points of 1 or 2 cm approximately, so as to avoid direct contact with the reflector surface, defining at its turn one or more air chambers between the insulating layer and the reflector.

As for the electric supply, the public lighting network is usually supplied with three-phase alternating current, with a nominal voltage of 220/380 V or 230/400 V depending on the standards of each country. At the base of each lighting post there is an electrical split or derivation 9, usually consisting of a mains and a ground cable which go through the inside of the lighting post until its upper top, where they get to the connection block 11 that is usually mounted on the components board 10, as previously said. The transceiver is connected to this connection block by a power adapter 5 or power supply, which allows the conversion from alternating current at 220 or 230 V to direct current at 12 V, made of a primary coil and a secondary coil, a rectifying circuit, one or more capacitors to smooth the power output, and optionally a regulator that stabilizes the output to a determined value, usually 12 V and in some cases also 5 V or 3.3 V.

Some examples of transceivers that operate in the radiofrequency band include those commonly used in wireless communications between computers in home or office environments, such as the hubs, switches or routers, compatible with the standard 802.11, which usually also have a connector that enables a wired connection for data input and output, and at least one antenna 4 operating in the radiofrequency band. Both the solutions based on the standard 802.11a and 802.11g offer similar characteristics of performance and reach. Although the standard 802.11g is a more widespread solution, the standard 802.11a operates in tile radiofrequency range of 5 Ghz, considerably less exposed to interference than the range of 2.4 Ghz that the standard 802.11g uses, and it has the advantage of having a higher number of non-overlapping channels (between 12 and 19 depending on the region), which is advantageous in distributions that involve a higher number of cells. Since both standards are not compatible, it is possible to use either dual transceivers that implement both solutions or a distribution that allows a mixed combination of nodes alternating both standards, although other solutions based in other codifications and other frequency ranges, such as 900 Mhz, 1800 Mhz or other ranges of the electromagnetic specter, may also be used.

In a particular embodiment of the invention, and to provide further functionality, the transceiver 2 may include in itself or be part of an integration board 22 that has a processor 23, a volatile memory 24 mainly for the purpose of storing instructions to be processed, and a non-volatile memory 25 mainly for the purpose of storing files or user documents, databases or an operating system, among others. This board has a connector 19 to receive electric power from the power adapter 5 or power unit, and a controller chipset 26 with the main function of coordinating the interruptions and different buses between components. This enables the node to provide additional services based on data transmission, such as remote data processing or remote data storage, so that it is possible, for example, the execution of remote applications or the recall and querying of files and documents previously stored.

It is clear therefore, that this type of luminaires is specially suited for providing services related to the world of information, and to data transmission in particular, being particularly interesting the case where this data transmission is performed by a certain number of this type of luminaires, so that a communications network based on a cellular distribution where each cell corresponds to each luminaire may be established in a urban environment.

The resulting communications system therefore comprises: a plurality of linear supports 20, each of which may have one or more receptacles 21 on its upper part, these receptacles preferably being luminaires. And at least a first network node 30, at least a second network node 40, and at least one user terminal 50, each of which comprising at least one transceiver 2, formed by at least one receiver and at least one transmitter which respectively have at least one data input and at least one data output coming from one or more antennas 4 that operate in the radiofrequency band, where said plurality of supports 20 or receptacles 21 presents an essentially uniform and elevated distribution that spreads in a road or urban environment; where those network nodes 30, 40 are elevated and supported by said plurality of supports 20 or receptacles 21; and where the transmitter 31 of the first node communicates with the receiver 42 of the second node, the transmitter 41 of the second node communicates with the receiver 52 of the user terminal, the transmitter 51 of the user terminal communicates with the receiver 42 of the second node, and the transmitter 41 of the second node communicates with the receiver 32 of the first node, said communication process being carried out by radiofrequency.

This way, each network node has at least one transceiver compatible with one or more transceivers belonging to its neighboring nodes, whereby it may communicate with them. Given the particular characteristics of the way the buildings are arranged in urban environments, it is appropriate to distinguish the different nodes between primary nodes and secondary nodes, where the secondary nodes essentially assume the function of providing network coverage to a certain area and to communicate with user terminals, and the primary nodes assume the function of communicating different secondary nodes between them, so that the communication between those secondary nodes requires a lower number of steps. For this reason, the primary nodes must be located in places with higher visibility, such as in corners or crossroads, and must generally be associated with cells that have a higher eccentricity than the secondary nodes.

Another kind of receptacles that presents similar characteristics to those of the housings of the light fixtures used in public lighting is the set of traffic lights used for the coordination of traffic in urban areas; specially those that are used to coordinate the traffic in important roads, since they arc installed at a higher height and have a better mutual visibility than those used in the coordination of pedestrian traffic. Conventional traffic lights are generally obtained through the vertical aggregation of a same single body, thereby forming groups of two or three bodies, each one essentially having a reflector, a diffuser, a visor and a piece of framework. In consequence, each of these bodies presents on its upper and lower sides the appropriate mechanisms for their mutual coupling, or for their attachment to the mounting post when it comes to the upper or lower ends. This way, it is possible to add another body besides the ones that constitute the traffic light itself, which presents the same coupling characteristics as the main bodies, but which has been specially conceived and designed to house and protect the transceiver and the power adapter.

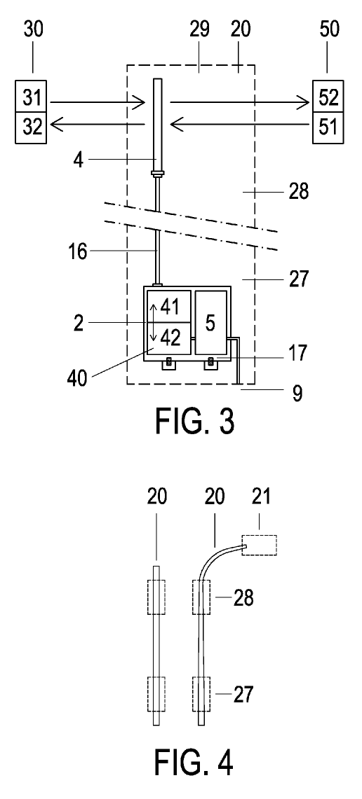

In another embodiment of the invention, as it is shown in FIGS. 3 and 4, the transceiver 2 and the power adapter 5 are not installed into the aforementioned housings, but rather into their mounting supports. This, in some cases, may present a much easier installation process, as is described below. Generally, this type of supports is divided in mounting posts and mounting arms, both of them being hollow and metallic in principle, where the former have their base on the urban pavement and the latter on a vertical surface, generally a facade.

The mounting posts 29 commonly used in public lighting, which are the ones that present both a greater elevation and a more uniform distribution, usually have a cross section with a diameter of between 6 and 8 cm at its top 28, and between 20 and 25 cm approximately at the base. Thus, when the transceiver is located at the lower part 27 of the mounting post it may be housed in its interior, preferably aligned vertically along its main axis, and at a height that may be accessed and operated from the registry, so that the mounting post 29 acts as an enclosure for the transceiver. In this case, the connection between the transceiver 2 and the antenna 4 is carried out by a wired connection 16, such as coaxial cable, which goes either by the inside of the mounting post, either by the outside, fixed to it by cramps, rings or any other means of physical fastening that surrounds it. In the first case, when the antenna is a collinear antenna or another type of vertical antenna, as is shown in the figure, it can be attached at the end of the wired connection, so that when the cable has the appropriate degree of rigidity the whole formed by the cable 16 and the antenna 4 may be installed inside die mounting post from its base without requiring any fastening means.

In those urban areas that do not have a lighting system, or when the number of supports is generally insufficient, it may be considered to implement the network by deploying mounting posts specifically designed to fulfill this new function. Given that this type of mounting posts 29 may usually be obtained by welding or joining two large and hollow semicircular pieces, it is possible to integrate the network components in its interior before the union of both parts. The fastening in this case of the transceiver 2 and the power adapter 5, as well as the antenna 4 and the cable 16, in one of the inner sides of the mounting post may be carried out by welding small metal plates or washers onto the lateral walls. In the case where the network components are assembled after the welding of the lighting post, as in the case where it is obtained by laminar folding, or in general when a previously existing post must be modified, it may be appropriate to secure both the transceiver and the power adapter by means of interior horizontal guides 17, which are fastened by pressure on the laterals, thus avoiding piercing the membrane of the lighting post.

Regarding the method for the installation of the equipment described above or similar equipment for obtaining this communications system, there are several alternatives from which to consider its implantation, namely:

A first option is based on a method of integral renovation where the existing elements are replaced by units specially conceived and manufactured not only to fulfill the traditional functions attributed to the replaced units, but which also have functionalities that enable them for data transmission. This method is preferable, corresponding with the luminaires previously described, since they are the elements that offer both a greater protection and ease of installation. This method is indicated in cases where the pre-existing elements have a certain age or exhibit wear, and have even been outperformed in their primitive functions by other equivalent products, or it is not possible to adapt them to house the required components for providing the new services.

A second option is the one that based on the previous method generates a limited number of units, which are used to replace the units of a certain metropolitan zone, whereas the replaced elements are reintroduced in the production line, thereby initiating a process of replacement of units by rotation. This method is indicated in cases where the existing units meet the required conditions regarding its state of conservation or adaptation possibilities.

A third option is the one wherein, unlike tile previous ones, the process of upgrading the pre-existing elements does not entail their removal but their adaptation in situ, by modifying, replacing or adding the needed components. This process is indicated where the availability of inner space allows a certain degree of maneuver or when the number of operations to perform is relatively small.

Hence, the method of replacement of units by renovation comprises the steps of:
i) Obtaining a number of units analogous to those that are to be replaced, which have optionally been provided with a space or compartment for the main purpose of housing the communications equipment, and have optionally been provided with means for the control of the inner temperature.
ii) Adding to each of these units previously obtained a network node including at least one transceiver with a data input and a data output coming from one or more antennas that operate in the radiofrequency band.
iii) Transporting these units to the replacement area.
iv) Replacing the pre-existing units by the units obtained by this process.
v) Discarding the pre-existing units.

The method of replacement of units by rotation is characterized because it comprises the actions mentioned above, except that the replaced element is not discarded in the last step, but it is reintroduced in the production line in point (i). This way, besides the mere addition of components, further actions need to be considered, particularly, the modification or replacement of existing components. In line therefore with the previous scheme, this method may also involve some of the following actions, preferably between steps (i) and (ii) previously indicated:
i) Replacing the component board of the pre-existing unit by a component board of smaller size, in order to facilitate the further addition of network components.
ii) Replacing the closing lid of the housing by a closing lid of such a form and size that defines a larger space on the inside, in order to facilitate the further addition of network components.
iii) Replacing the closing lid of the housing by a closing lid where one ore more, holes have been drilled, in order to facilitate the cooling of the equipment on the inside or for passing installations.

The adaptation of units by modification in situ may also involve these last set of actions, although the processes of adding, modifying or replacing any of the components are not carried out in a specialized environment, but locally at the same area of replacement, without removing the units themselves but just the particular components of each unit.

In the particular case where the element to adapt for the new services is a lighting post, it is possible to house the network node in its lower part, guiding both the antenna and the cable that connects it to the network node upwards through the inside, as it has been previously described. This implies a relatively simple method of implantation of the network, since in most cases it avoids having to operate on the top of the lighting post. In urban zones without lighting systems, or when the number of supports is generally insufficient, the implantation of the network may be carried out through the installation of lighting posts or lighting fixtures specifically designed to fulfill this new application, which have been previously adapted with the required components for data transmission.

It is not needed to extend this specification so that any person skilled in the art may understand the reach of the invention and its advantages. The materials, form, size and configuration of the elements involved, as well as the particular characteristics of the transceiver, are subject to variation as long as this does not entail an alteration of the essentiality of the invention. The terms used in this specification should be taken in a broad sense and without limitation to its scope. Accordingly, the scope of the invention should be determined by the following claims and their legal equivalents.

1. Device for radiofrequency communication in urban or road environments, comprising a luminaire of common use in public lighting, which incorporates at least one transceiver with at least one data input and at least one data output coming from one or more antennas that operate in the radiofrequency band, said luminaire being provided with at least one space or compartment for housing said transceiver.

2. Device for radiofrequency communication in urban or road environments, comprising a luminaire of common use in public lighting, which incorporates at least one transceiver with at least one data input and at least one data output coming from one or more antennas that operate in the radiofrequency band, where said transceiver includes the means to communicate with at least a second transceiver installed in at least a second luminaire of similar characteristics.

3. Device for radiofrequency communication according to claims 1 or 2, wherein said transceiver is located in the inner space of said luminaire comprised between the reflector and the rear part of the housing.

4. Device for radiofrequency communication according to claim 3, wherein said transceiver is attached to the inner side of the closing lid of the housing of said luminaire.

5. Device for radiofrequency communication according to claims 1 or 2, wherein said transceiver is housed in a separated compartment in relation to the reflector of said luminaire.

6. Device for radiofrequency communication according to claims 1 or 2, comprising a fan on the receiving end of said luminaire.

7. Device for radiofrequency communication according to claims 1 or 2, comprising a thermally insulating coating around the reflector of said luminaire, where said insulating coating, being separated of said reflector by small supporting points, may define one or more air chambers.

8. Device for radiofrequency communication according to claims 1 or 2, comprising a power adapter which provides electric supply to said radiofrequency transceiver.

9. Device for radiofrequency communication according to claims 1 or 2, wherein said transceiver is a hub, a switch or a router, which may have a wired connection for data input and data output, and wherein said one or more antennas to which said transceiver is connected to operate in at least one of the radiofrequency ranges of 2.4 Ghz or 5 Ghz, approximately.

10. Device for radiofrequency communication according to claims 1 or 2, wherein said transceiver comprises in itself, or is connected to a board that integrates, at least one microprocessor and at least one volatile memory associated to said at least one microprocessor.

11. Device for radiofrequency communication according to claims 1 or 2, wherein said transceiver comprises in itself, or is connected to a board that integrates, at least a means of non-volatile memory.

12. Radiofrequency communications system in urban or road areas, comprising a plurality of linear supports, each of which may present one or more receptacles on its upper part, and at least a first network node, at least a second network node, and at least a user terminal, each of which comprising at least one transceiver, formed by at least one receiver and at least one transmitter with at least one data input and at least one data output coming from one or more antennas operating in the radiofrequency band, wherein:
said plurality of supports or receptacles presents a distribution that spreads in an essentially uniform and elevated way on the public space of a urban or road environment;
said network nodes are elevated and supported by means of said plurality of supports or receptacles; and
said transmitter of said first node communicates with said receiver of said second node, said transmitter of said second node communicates with said receiver of said user terminal, said transmitter of said user terminal communicates with said receiver of said second node, and said transmitter of said second node communicates with said receiver of said first node.

13. Radiofrequency communications system according to claim 12, wherein said transceiver is located on the inside of said support or receptacle, constituting said support or receptacle an enclosure of said transceiver.

14. Radiofrequency communications system according to claim 12, wherein said support or receptacle comprises at least one power adapter that provides electric supply to said at least one transceiver.

15. Radiofrequency communications system according to claim 12, wherein:
said transceiver is a hub, a switch or a router, which may have a wired connection for data input and data output; and
said one or more antennas to which said transceiver is connected to operate in at least one of the radiofrequency ranges of 2.4 Ghz or 5 Ghz, approximately.

16. Radiofrequency communications system according to claim 12, wherein the eccentricity of the cell of said at least one first node is greater than the eccentricity of the cell of said at least one second node.

17. Radiofrequency communications system according to claims 12 or 13, wherein said receptacle is a luminaire.

18. Radiofrequency communications system according to claims 12 or 13, wherein said receptacle is a traffic light.

19. Radiofrequency communications system according to claim 18, wherein said transceiver and said power adapter are housed in an additional body attached to the main bodies that constitute the traffic light itself.

20. Radiofrequency communications system according to claims 12 or 13, wherein said supporting element is a lighting post or a traffic light post.

21. Radiofrequency communications system according to claims 12 or 13, wherein said supporting element is an arm, attached to a vertical surface.

22. Radiofrequency communications system according to claim 13, wherein said radiofrequency transceiver is located in the lower part of said supporting element, said antenna is installed on the upper part, and the connection between said transceiver and said antenna is carried out by means of a wired connection.

23. Radiofrequency communications system according to claim 22, wherein the fastening means of said radiofrequency transceiver to said post comprise one or more interior guides, which are set transverse to the main direction of the post and fastened by pressure on the lateral walls.

24. Method for obtaining a radiofrequency communications system that presents an essentially uniform and elevated distribution on the public space of a urban or road area, involving the steps of:
obtaining a plurality of supports or receptacles;
adding at least one radiofrequency transceiver and at least one power adapter to said plurality of supports or receptacles;
transporting said plurality of supports or receptacles to a replacement environment, where said replacement environment comprises a second plurality of supports or receptacles that do not have a radiofrequency transceiver; and
replacing said second plurality of supports or receptacles by said first plurality of supports or receptacles.

25. Method according to claim 24, involving the steps of:
transporting said second plurality of supports or receptacles to an industrial environment;
adding at least one radiofrequency transceiver and at least one power adapter to said second plurality of supports or receptacles;
transporting said second plurality of supports or receptacles to a replacement environment, where said replacement environment comprises a third plurality of supports or receptacles that do not have a radiofrequency transceiver; and
replacing said third plurality of supports or receptacles by said second plurality of supports or receptacles.

26. Method according to claims 24 or 25, involving the steps of:
replacing the component board of at least one receptacle belonging to said second plurality of receptacles by a component board of smaller size.

27. Method according to claims 24 or 25, involving the steps of:
replacing the closing lid of at least one receptacle belonging to said second plurality of receptacles by a closing lid of such a form and dimensions that defines a wider space on the inside of said at least one receptacle.

28. Method for obtaining a radiofrequency communications system that presents an essentially uniform and elevated distribution on the public space of a urban or road area, involving the steps of:
selecting at least one post which is located within the reach of at least one of the cells of said communications system;
introducing on the inside of said post: a network node comprising at least one transceiver with at least one data input and at least one data output coming from one or more antennas that operate in the radiofrequency band, where said antenna is connected to said transceiver by means of a wired connection, and where said wired connection is rigid enough to support itself on the inside of said post; and
guiding through the inside of said post the whole formed by said antenna and said wired connection, until both keep lodged on the upper part of said post.

29. Method for obtaining a radiofrequency communications system that presents an essentially uniform and elevated distribution on the public space of a urban or road area, involving the steps of:
obtaining a plurality of supports in an industrial environment;
adding at least one radiofrequency transceiver and at least one power adapter to said plurality of supports; and
transporting said plurality of supports to one or more locations that are within the reach of at least one of the cells of said communications system.

30. Method according to claim 24, involving the steps of:
adding at least one processor, at least one volatile memory and at least one non-volatile memory to said plurality of supports or receptacles.
